(19) United States
(12) Patent Application Publication
(10) Pub. No.: US 2018/0218180 A1
(43) Pub. Date: Aug. 2, 2018

(54) ATTACHING STRUCTURE OF CARD PROCESSING UNIT AND CARD ISSUING DEVICE

(71) Applicant: NIDEC SANKYO CORPORATION, Suwa-gun Nagano (JP)

(72) Inventors: Ryo UCHIYAMA, Suwa-gun Nagano (JP); Keiji OHTA, Suwa-gun Nagano (JP)

(21) Appl. No.: 15/881,062

(22) Filed: Jan. 26, 2018

(30) Foreign Application Priority Data
Jan. 27, 2017 (JP) 2017-013527

(51) Int. Cl. G06K 7/00

(52) U.S. Cl. CPC G06K 7/0004; G06K 7/0056

(57) ABSTRACT

An attaching structure of a card processing unit may include the card processing unit and an attaching frame. The attaching frame includes a frame side restriction part that restricts a movement of the card processing unit in a conveying direction, a thickness direction and a width direction of a card, and the card processing unit includes a processing unit side restriction part structured to engage with the frame side restriction part. For example, the frame side restriction part includes an engaging part structured to engage with a part of the processing unit side restriction part to restrict the movement of the card processing unit. The engaging part is an elastic piece capable of being elastically deformed from a restricting position where the movement of the card processing unit is restricted to a release position and the engaging part is engaged with the processing unit side restriction part by snap fitting.

### CROSS REFERENCE TO RELATED APPLICATION

The present application claims priority under 35 U.S.C. § 119 to Japanese Application No. 2017-013527 filed Jan. 27, 2017, the entire content of which is incorporated herein by reference.

### FIELD OF THE INVENTION

At least an embodiment of the present invention may relate to an attaching structure of a card processing unit which includes a card processing unit structured to perform predetermined processing to a card and an attaching frame to which the card processing unit is attached. Further, at least an embodiment of the present invention may relate to a card issuing device which includes the attaching structure of a card processing unit.

### BACKGROUND

Conventionally, a card issuing device has been known which includes a card reader, a card issuing and collecting part which performs issue and collection of a card, and a mounting part on which the card reader is mounted (see, for example, Japanese Patent Laid-Open No. 2013-20283). In the card issuing device described in the Patent Literature, the mounting part is formed of sheet steel and the card reader is fixed to the mounting part by using a screw.

In the card issuing device described in the Patent Literature, a screw is required for fixing the card reader to the mounting part and thus the number of components of the card issuing device is increased. Further, in the card issuing device, the card reader is required to be fixed to the mounting part by using a screw and thus it takes time to attach the card reader to the mounting part.

### SUMMARY

In view of the problem described above, at least an embodiment of the present invention may advantageously provide an attaching structure of a card processing unit which comprises a card processing unit structured to perform predetermined processing on a card and an attaching frame to which the card processing unit is attached, the attaching structure being capable of reducing the number of components and shortening an attaching time. Further, at least an embodiment of the present invention may advantageously provide a card issuing device comprising the attaching structure of the card processing unit.

According to at least an embodiment of the present invention, there may be provided an attaching structure of a card processing unit including the card processing unit structured to perform predetermined processing on a card and an attaching frame to which the card processing unit is attached. When a direction which is perpendicular to a conveying direction of the card conveyed in the card processing unit and is perpendicular to a thickness direction of the card conveyed in the card processing unit is referred to as a width direction of the card, the attaching frame comprises a frame side restriction part structured to restrict a relative movement of the card processing unit with respect to the attaching frame in the conveying direction of the card, the thickness direction of the card and the width direction of the card, and the card processing unit comprises a processing unit side restriction part structured to engage with the frame side restriction part to restrict the relative movement of the card processing unit with respect to the attaching frame in the conveying direction of the card, the thickness direction of the card and the width direction of the card. Further, one of the frame side restriction part and the processing unit side restriction part comprises an engaging part structured to engage with a part of the other of the frame side restriction part and the processing unit side restriction part to restrict the relative movement of the card processing unit with respect to the attaching frame toward a first restriction direction, the first restriction direction being at least a one-side direction in the conveying direction of the card, at least a one-side direction in the thickness directions of the card, or at least a one-side direction in the width directions of the card. The engaging part is an elastic piece which is capable of being elastically deformed from a restricting position where the relative movement of the card processing unit with respect to the attaching frame toward the first restriction direction is restricted to a release position where restriction of the relative movement of the card processing unit with respect to the attaching frame toward the first restriction direction is released, and the engaging part is engaged with the part of the other of the frame side restriction part and the processing unit side restriction part by snap fitting.

In the attaching structure of the card processing unit in at least an embodiment of the present invention, relative movements of the card processing unit with respect to the attaching frame in a conveying direction of a card and a thickness direction of the card and a width direction of the card are restricted by the frame side restriction part of the attaching frame and the processing unit side restriction part of the card processing unit. Therefore, according to at least an embodiment of the present invention, a screw for fixing the card processing unit to the attaching frame is not required. Accordingly, in at least an embodiment of the present invention, the number of components of the attaching structure of the card processing unit can be reduced.

Further, in at least an embodiment of the present invention, one of the frame side restriction part and the processing unit side restriction part comprises an engaging part structured to engage with a part of the other of the frame side restriction part and the processing unit side restriction part to restrict a relative movement of the card processing unit with respect to the attaching frame toward a first restriction direction. The first restriction direction is both directions in the conveying direction of the card, a one-side direction in the conveying direction of the card, both directions in the thickness direction of the card, a one-side direction in the thickness direction of the card, both directions in the width direction of the card, or a one-side direction in the width direction of the card. The engaging part is an elastic piece which is capable of being elastically deformed from a restricting position, where a relative movement of the card processing unit with respect to the attaching frame toward the first restriction direction is restricted, to a release position where restriction of the relative movement of the card processing unit with respect to the attaching frame toward the first restriction direction is released, and the engaging part is engaged with the part of the other of the frame side restriction part and the processing unit side restriction part by snap fitting. Therefore, according to at least an embodiment of the present invention, the card processing unit can be fixed to the attaching frame by snap fitting utilizing elasticity of the engaging part which restricts the relative movement of the card processing unit with respect to the attaching frame to the first restriction direction. Accordingly, in at least an embodiment of the present invention, an attaching time of the card processing unit to the attaching frame can be shortened in comparison with a case that the card processing unit is fixed to the attaching frame with a screw.

In at least an embodiment of the present invention, it is preferable that the attaching frame is formed of resin, the engaging part is formed in the attaching frame, the attaching frame is formed with a frame side attaching face in a flat face shape to which the card processing unit is attached, and the card processing unit comprises an attached part in a flat plate shape which is formed with a processing unit side attaching face in a flat face shape that is contacted with the frame side attaching face. The frame side attaching face and the processing unit side attaching face are formed to be flat faces perpendicular to the thickness direction of the card, the frame side restriction part comprises a projecting part structured to restrict a relative movement of the card processing unit with respect to the attaching frame in three directions or four directions except the first restriction direction and a one-side direction in the thickness direction of the card, the projecting part is protruded to a side of the card processing unit with respect to the frame side attaching face, and a part of the attached part is the processing unit side restriction part.

According to this structure, the engaging part which is an elastic piece and the projecting part are formed in the attaching frame made of resin, the engaging part and the projecting part can be formed easily. Further, according to this structure, the engaging part which is an elastic piece and the projecting part are not formed in the card processing unit and thus a structure of the card processing unit can be simplified. Further, according to this structure, a relative movement of the card processing unit with respect to the attaching frame in three directions or four directions except the first restriction direction and a one-side direction in the thickness direction of the card can be restricted by using the projecting part and thus a structure of the attaching frame can be simplified.

In at least an embodiment of the present invention, for example, the first restriction direction is at least a one-side direction in the conveying direction of the card, and the attached part is formed with a first contact face structured to contact with the engaging part to restrict a relative movement of the card processing unit with respect to the attaching frame toward the first restriction direction, a second contact face structured to contact with the projecting part to restrict a relative movement of the card processing unit with respect to the attaching frame toward the width direction of the card, and a third contact face structured to contact with the projecting part to restrict a relative movement of the card processing unit with respect to the attaching frame toward the other direction in the thickness direction of the card. In addition, the projecting part comprises a first contact part structured to contact with the second contact face and a second contact part structured to contact with the third contact face. In this case, a relative movement of the card processing unit with respect to the attaching frame in the conveying direction of the card, the thickness direction of the card and the width direction of the card can be restricted with a relatively simple structure.

In at least an embodiment of the present invention, for example, the first restriction direction is a one-side direction in the conveying direction of the card, and the attached part is formed with a fourth contact face structured to contact with the first contact part to restrict a relative movement of the card processing unit with respect to the attaching frame toward an opposite direction to the first restriction direction.

In at least an embodiment of the present invention, for example, the projecting part is structured of the first contact part and the second contact part, the first contact part is formed so as to extend to one side in the thickness direction of the card, the second contact part is formed so as to extend from a tip end of the first contact part to one side in the conveying direction of the card, and a shape of the projecting part when viewed in the width direction of the card is an “L”-shape.

In at least an embodiment of the present invention, for example, the attached part is a bottom face part which structures an under face of the card processing unit and is formed of sheet steel, and the bottom face part comprises a first cut-out part which is formed by cutting out an end face of the bottom face part to an inner side in the width direction of the card and is structured to be engaged with the engaging part formed in the attaching frame, and a second cut-out part which is formed by cutting out the end face of the bottom face part to an inner side in the width direction of the card and is structured to engage with the projecting part formed in the attaching frame. When the card processing unit is attached to the attaching frame, the engaging part formed in the attaching frame is engaged with the first cut-out part and the projecting part formed in the attaching frame is engaged with the second cut-out part. In this case, it may be structured that the first cut-out part provided in the bottom face part comprises a first contact face structured to contact with the engaging part to restrict a movement of the bottom face part with respect to the attaching frame toward the first restriction direction, the second cut-out part provided in the bottom face part comprises a second contact face structured to contact with the projecting part to restrict a movement of the bottom face part with respect to the attaching frame toward the width direction of the card, and the projecting part comprises a first contact part structured to contact with the second contact face and a second contact part structured to restrict a movement of the bottom face part toward the other direction in the thickness direction of the card.

In at least an embodiment of the present invention, for example, the projecting part is provided at both end parts of the attaching frame in the width direction of the card, the second cut-out part formed in the bottom face part is provided at two positions so as to correspond to the projecting parts provided at the both end parts of the attaching frame in the width direction of the card, and the second cut-out parts provided at two positions in the bottom face part are structured to contact with the projecting parts to restrict a movement of the bottom face part in the width direction of the card. In this case, a movement of the card processing unit with respect to the attaching frame in the width direction of the card can be surely restricted.

In at least an embodiment of the present invention, for example, the engaging part is a tongue piece part formed in a tongue piece shape which is connected with a main body part of the attaching frame, and a tip end of the tongue piece part is provided with a protruded part structured to engage with the first cut-out part formed in the bottom face part. When the card processing unit is to be attached to the attaching frame, the card processing unit is slid on the frame side attaching face in the flat face shape in a state that the tongue piece part provided with the protruded part is elastically deformed to the release position, and thereby the first cut-out part formed in the bottom face part and the protruded part provided at the tip end of the tongue piece part are engaged with each other. As described above, when the engaging part is formed in a tongue piece shape which is connected with a main body part of the attaching frame, the engaging part can be elastically deformed to a release position where restriction of a relative movement of the card processing unit with respect to the attaching frame is released with a simple structure.

In at least an embodiment of the present invention, it is preferable that the attaching structure of a card processing unit includes a lock member structured to prevent the engaging part from being elastically deformed from the restricting position to the release position. The engaging part is formed in the attaching frame, the attaching frame is formed with a third cut-out part structured to permit the engaging part to elastically deform from the restricting position to the release position, and the lock member is fitted to the third cut-out part. According to this structure, after the card processing unit is attached to the attaching frame, the card processing unit can be prevented from being disengaged from the attaching frame due to elastic deformation of the engaging part from the restricting position to the release position.

In at least an embodiment of the present invention, it is preferable that the lock member is formed in a substantially “U”-shape, and the lock member is engaged with the third cut-out part by snap fitting. According to this structure, even when the lock member for preventing elastic deformation of the engaging part from the restricting position to the release position is provided, an attaching time of the card processing unit to the attaching frame can be shortened.

The attaching structure of a card processing unit in at least an embodiment of the present invention may be used in a card issuing device which includes a card cassette in which cards before issue are accommodated in a stacked state, a cassette attachment and detachment frame to which the card cassette is detachably attached, and a card feed mechanism structured to feed out the card from the card cassette toward the card processing unit. In the card issuing device, the attaching frame and the cassette attachment and detachment frame are formed of resin and are integrally formed with each other. According to the card issuing device, the number of components of the card issuing device can be reduced and an attaching time of the card processing unit to the attaching frame can be shortened.

In at least an embodiment of the present invention, for example, the card processing unit and the card cassette are disposed so as to be adjacent to each other in the conveying direction of the card, the first restriction direction is at least a one-side direction in the conveying direction of the card and, when a side where the card processing unit is disposed with respect to the card cassette in the conveying direction of the card is referred to as a front side, a front face of the cassette attachment and detachment frame is formed with a positioning projection structured to position the card processing unit with respect to the cassette attachment and detachment frame at least one in the thickness direction of the card and the width direction of the card. In this case, even when the positioning projection is formed on a front face of the cassette attachment and detachment frame, the card processing unit can be attached to the attaching frame from a front side in a state that the engaging part is elastically deformed to the release position.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a side view showing a card issuing device in accordance with at least an embodiment of the present invention.

FIG. 2 is a perspective view showing the “E” part in FIG. 1.

FIG. 3 is a perspective view showing a main body frame shown in FIG. 1.

FIG. 4 is an enlarged view showing the “F” part in FIG. 3.

FIG. 5 is a perspective view showing a card reader in FIG. 1.

FIG. 6 is a perspective view showing a lock member in FIG. 2.

FIGS. 7A and 7B are views for explaining a fitting state of a lock member to a cut-out part of an attaching frame shown in FIG. 4.

### DETAILED DESCRIPTION

At least an embodiment of the present invention will be described below with reference to the accompanying drawings.

(Schematic Structure of Card Issuing Device)

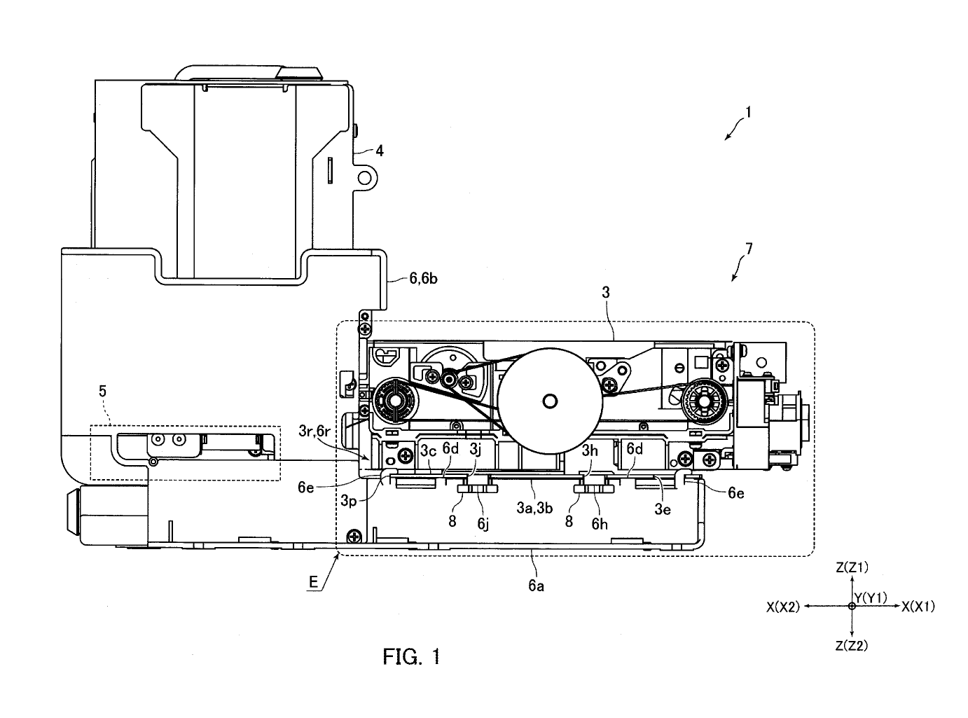

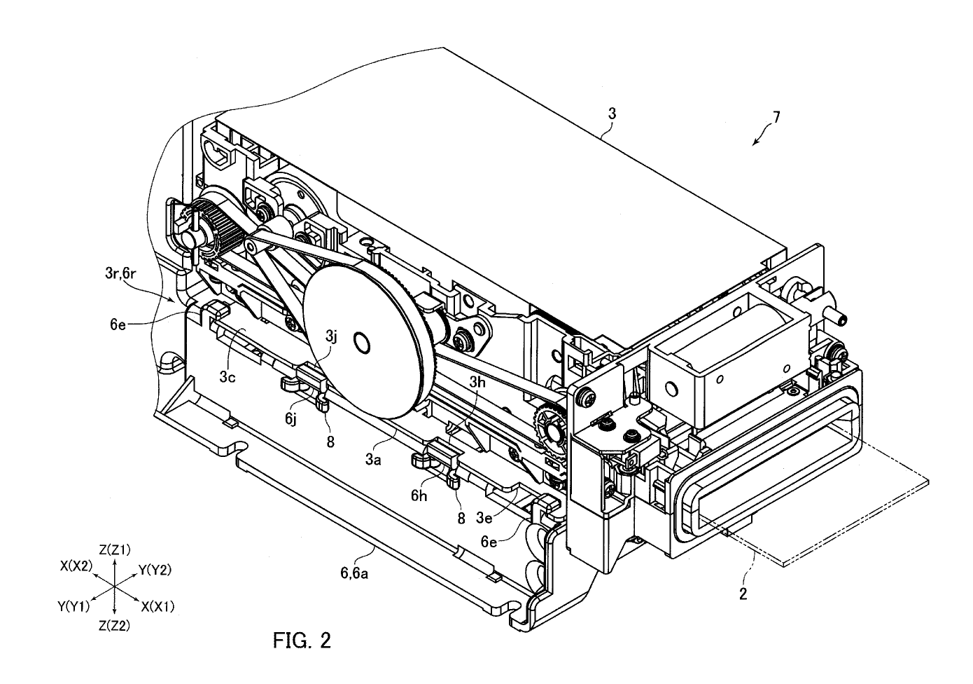

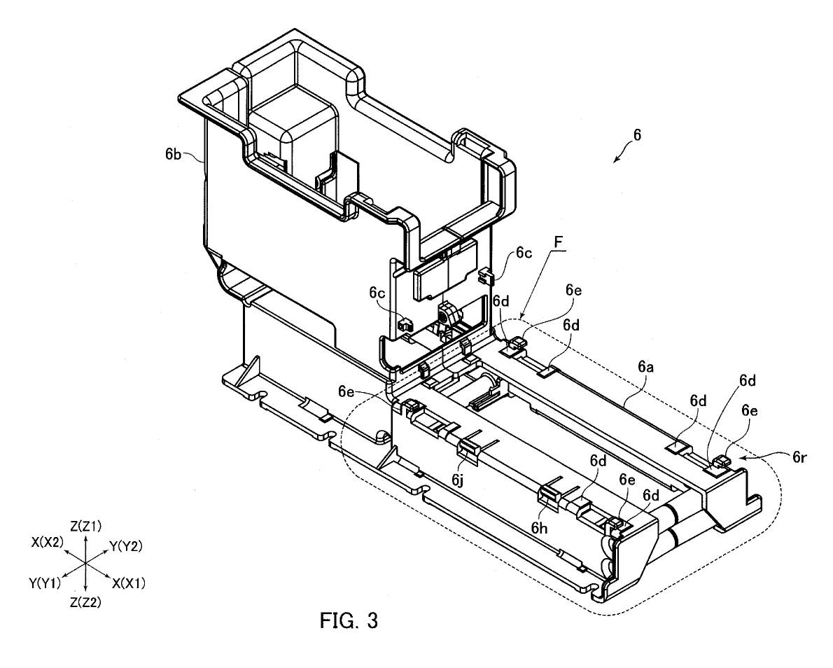

FIG. 1 is a side view showing a card issuing device 1 in accordance with at least an embodiment of the present invention. FIG. 2 is a perspective view showing the “E” part in FIG. 1. FIG. 3 is a perspective view showing a main body frame 6 shown in FIG. 1.

A card issuing device 1 in this embodiment includes a card processing unit 3 structured to perform predetermined processing on a card 2 (see FIG. 2), a card cassette 4 in which cards 2 before issue are accommodated, a card feed mechanism 5 structured to feed out a card 2 from the card cassette 4 toward the card processing unit 3, and a main body frame 6. The card processing unit 3 in this embodiment is a card reader structured to perform at least one of reading of data recorded in a card 2 and recording of data to a card 2. Therefore, hereinafter, the card processing unit 3 in this embodiment is referred to as a “card reader 3”. The card reader 3 is a card conveyance type card reader having a conveying mechanism for a card 2.

A card 2 is, for example, a rectangular card made of vinyl chloride whose thickness is about 0.7-0.8 mm. The card 2 is, for example, formed with a magnetic stripe in which magnetic data are recorded. Further, an IC chip is, for example, incorporated in the card 2. The card 2 is conveyed in the card reader 3 so that a longitudinal direction of the card 2 formed in a rectangular shape and a conveying direction of the card 2 are coincided with each other. In accordance with at least an embodiment of the present invention, the card 2 may be a PET (polyethylene terephthalate) card whose thickness is about 0.18-0.36 mm or may be a paper card having a predetermined thickness.

In this embodiment, a card 2 is conveyed in the “X” direction shown in FIG. 1 and the like in the card reader 3. In other words, the “X” direction is a conveying direction of a card 2 which is conveyed in the card reader 3. Further, the “Z” direction in FIG. 1 and the like perpendicular to the “X” direction is a thickness direction of a card 2 conveyed in the card reader 3, and the “Y” direction in FIG. 1 and the like perpendicular to the “X” direction and the “Z” direction is a width direction (short width direction) of a card 2 conveyed in the card reader 3.

Further, in this embodiment, the “Z” direction is coincided with a vertical direction and thus the “Z” direction is referred to as an upper and lower direction in the following descriptions. Further, the “X” direction is referred to as a front and rear direction, and the “Y” direction is referred to as a right and left direction. Further, the “X1” direction side in the front and rear direction is referred to as a “front” side, the “X2” direction side which is the opposite side is as a “rear” side, the “Y1” direction side in the right and left direction is as a “left” side, the “Y2” direction side which is the opposite side is as a “right” side, the “Z1” direction side in the upper and lower direction is an “upper” side, and the “Z2” direction side which is the opposite side is as a “lower” side.

The card reader 3 structures a front side portion of the card issuing device 1. A card conveyance passage where a card 2 is conveyed is formed in an inside of the card reader 3. Further, the card reader 3 includes a magnetic head structured to perform reading of magnetic data recorded on a card 2 and recording of magnetic data to a card 2, an IC contact structured to contact with an external connection terminal of an IC chip formed on a surface of the card 2 to perform data communication, and the like. The card reader 3 is also structured to record data in a card 2 which is fed out from the card cassette 4 and to eject the card 2 from a front face of the card reader 3. When the card 2 is ejected from the front face of the card reader 3, issue of the card 2 in the card issuing device 1 is completed.

The main body frame 6 includes an attaching frame 6a to which the card reader 3 is attached and a cassette attachment and detachment frame 6b to which a card cassette 4 is detachably attached. The main body frame 6 is formed of resin. In other words, the attaching frame 6a and the cassette attachment and detachment frame 6b are made of resin. Further, the attaching frame 6a and the cassette attachment and detachment frame 6b are integrally formed each other. In this embodiment, the main body frame 6 is structured of two divided frames which are divided into two portions in the right and left direction.

The attaching frame 6a structures a front side portion of the main body frame 6. The card reader 3 is placed on and fixed to an upper face of the attaching frame 6a. In this embodiment, an attaching structure 7 of a card reader as an attaching structure of a card processing unit is structured of the card reader 3, the attaching frame 6a and the like. A detailed structure of the attaching structure 7 of a card reader will be described below.

A cassette attachment and detachment frame 6b is disposed on a rear side with respect to the attaching frame 6a. Further, the cassette attachment and detachment frame 6b is disposed on an upper side with respect to the attaching frame 6a and is disposed on a rear side with respect to the card reader 3. The cassette attachment and detachment frame 6b is formed in a rectangular parallelepiped box shape whose upper face is opened. A front face of the cassette attachment and detachment frame 6b is formed with positioning projections 6c (see FIG. 3) for positioning the card reader 3 with respect to the cassette attachment and detachment frame 6b in at least one of the right and left direction and the upper and lower direction.

The positioning projection 6c is formed so as to protrude from the front face of the cassette attachment and detachment frame 6b to a front side. Further, the positioning projection 6c is formed at two positions on both end sides in the right and left direction of the front face of the cassette attachment and detachment frame 6b. The positioning projections 6c in this embodiment position the card reader 3 with respect to the cassette attachment and detachment frame 6b in the upper and lower direction. The card reader 3 is formed with engagement holes with which the positioning projections 6c are engaged.

The card cassette 4 is formed in a substantially rectangular parallelepiped box shape which is long and thin in the upper and lower direction. Cards 2 before issue are stacked and accommodated in the upper and lower direction in the card cassette 4. Further, each of the cards 2 is accommodated in the card cassette 4 so that a longitudinal direction of the card 2 and the front and rear direction are coincided with each other and a short-side direction of the card 2 and the right and left direction are coincided with each other. The card cassette 4 is disposed on a rear side with respect to the card reader 3. In other words, the card reader 3 is disposed on a front side with respect to the card cassette 4. Further, the card reader 3 and the card cassette 4 are disposed so as to be adjacent to each other in the front and rear direction. The card cassette 4 is capable of being attached to and detached from the cassette attachment and detachment frame 6b from an upper side.

The card feed mechanism 5 is disposed on a lower side with respect to the card cassette 4. The card feed mechanism 5 includes, for example, a feeding pawl structured to engage with a card 2 of a plurality of cards 2 accommodated in the card cassette 4 which is disposed at a lowest position and to feed out the card 2 toward the card reader 3, a pawl feed mechanism structured to move the feeding pawl, and the like. The pawl feed mechanism includes, for example, a chain to which the feeding pawl is fixed, sprockets over which the chain is extended, a motor structured to rotate the sprockets, and the like.

(Attaching Structure of Card Reader)

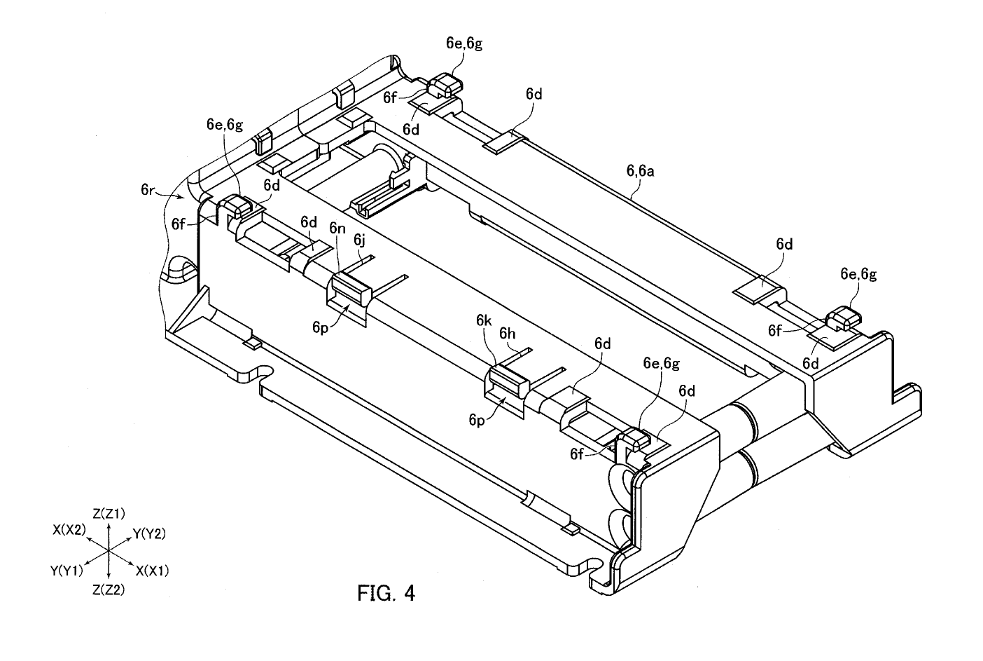

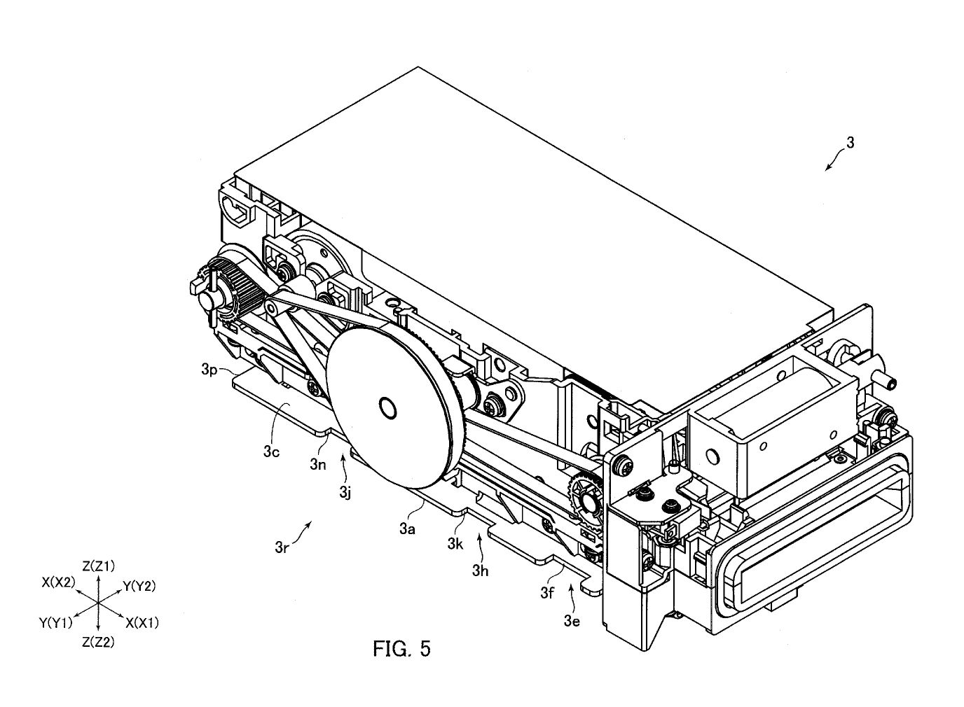

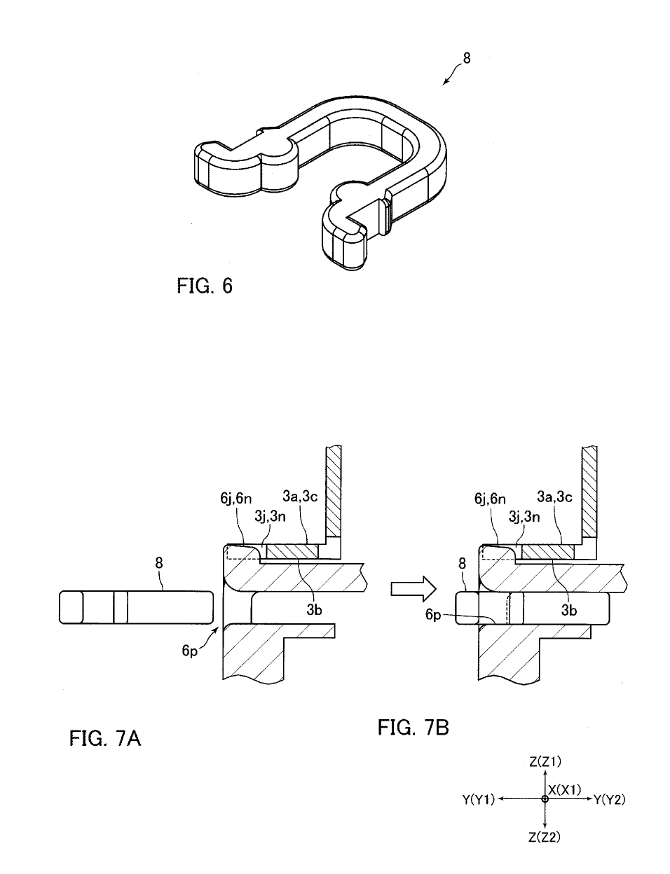

FIG. 4 is an enlarged view showing the “F” part in FIG. 3. FIG. 5 is a perspective view showing the card reader 3 in FIG. 1. FIG. 6 is a perspective view showing a lock member 8 in FIG. 2. FIGS. 7A and 7B are views for explaining a fitting state of a lock member 8 to a cut-out part 6p shown in FIG. 4.

The attaching structure 7 of a card reader is structured of the card reader 3, the attaching frame 6a, and two lock members 8 for surely fixing the card reader 3 to the attaching frame 6a. An outward shape of the attaching frame 6a is formed in a flat and substantially rectangular parallelepiped shape whose thickness in the upper and lower direction is thin, and right and left side faces of the attaching frame 6a are flat faces perpendicular to the right and left direction. The card reader 3 is formed in a substantially rectangular parallelepiped shape and, as described above, the card reader 3 is placed on and fixed to an upper face of the attaching frame 6a.

An upper face of the attaching frame 6a is formed with attaching faces 6d in a flat face shape to which the card reader 3 is attached (in other words, on which the card reader 3 is placed). The attaching face 6d is a flat face which is perpendicular to the upper and lower direction. Further, the attaching face 6d is, as shown in FIG. 4, formed at totaled eight (8) positions, i.e., at four positions on a right end side and four positions on a left end side of the upper face of the attaching frame 6a. Four attaching faces 6d formed on the right end side of the upper face of the attaching frame 6a are formed in a separated state with a predetermined space therebetween in the front and rear direction, and four attaching faces 6d formed on the left end side of the upper face of the attaching frame 6a are formed in a separated state with a predetermined space therebetween in the front and rear direction. The attaching face 6d in this embodiment is a frame side attaching face, and the card reader 3 can be attached to the attaching frame 6a by sliding the card reader 3 to a rear side in the front and rear direction.

The card reader 3 includes a bottom face part 3a structuring a bottom face of the card reader 3. The bottom face part 3a is formed of sheet steel. Further, the bottom face part 3a is formed in a flat plate shape and is disposed so that a thickness direction of the bottom face part 3a and the upper and lower direction are coincided with each other. The bottom face part 3a is provided at two positions on both end sides in the right and left direction of the card reader 3. An under face 3b of the bottom face part 3a (in other words, an under face of the card reader 3, see FIG. 1) is formed in a flat face shape contacting with the attaching face 6d. In other words, the under face 3b is a flat face perpendicular to the upper and lower direction. Further, an upper face 3c of the bottom face part 3a is also a flat face perpendicular to the upper and lower direction. The under face 3b in this embodiment is a processing device side attaching face, and the bottom face part 3a is an attached part.

The attaching frame 6a is formed with projecting parts 6e which are protruded to an upper side from the main body part of the attaching frame 6a. The projecting part 6e is protruded to an upper side with respect to the attaching face 6d. In other words, the projecting part 6e is protruded to the card reader 3 side with respect to the attaching face 6d. Further, the projecting part 6e is formed at four positions of the upper face of the attaching frame 6a. Specifically, the projecting part 6e is formed at four positions, i.e., a right front end part, a left front end part, a right rear end part and a left rear end part of the upper face of the attaching frame 6a. In other words, the projecting part 6e is provided at both end parts in the width direction of a card 2.

A shape of the projecting part 6e when viewed in the right and left direction is an “L”-shape. The projecting part 6e is structured of a first contact part 6f formed so as to be extended to an upper side and a second contact part 6g which is extended from a tip end (upper end) of the first contact part 6f to a front side. A front face of the first contact part 6f is a flat face perpendicular to the front and rear direction. Right and left side faces of the first contact part 6f are flat faces perpendicular to the right and left direction. An under face of the second contact part 6g is a flat face perpendicular to the upper and lower direction. A distance in the upper and lower direction between the under face of the second contact part 6g and the attaching face 6d is substantially equal to a thickness of the bottom face part 3a (thickness in the upper and lower direction).

Two tongue piece parts 6h and 6j which are capable of being elastically deformed in the upper and lower direction are formed on a left end side of the upper face of the attaching frame 6a. The two tongue piece parts 6h and 6j are formed in a separated state with a space therebetween in the front and rear direction. The tongue piece part 6h is disposed on a front side and the tongue piece part 6j is disposed on a rear side. The tongue piece part 6h and the tongue piece part 6j are formed in the same shape as each other. The tongue piece parts 6h and 6j are formed in a tongue piece shape so that right ends of the tongue piece parts 6h and 6j are connected with the main body part of the attaching frame 6a and are formed to be elastic pieces which are capable of being elastically deformed in the upper and lower direction with the right ends of the tongue piece parts 6h and 6j as supporting points.

A cutting part in a slit shape is formed on both sides in the front and rear direction of the tongue piece parts 6h and 6j. Cut-out parts 6p (third cut-out part) are formed on lower sides of the tongue piece parts 6h and 6j so that the tongue piece parts 6h and 6j are capable of being elastically deformed to a lower side. A tip end (left end) of the tongue piece part 6h is formed with a protruded part 6k which is protruded to an upper side, and a tip end (left end) of the tongue piece part 6j is formed with a protruded part 6n which is protruded to an upper side. In other words, the tongue piece part 6h is provided with the protruded part 6k at a tip end of the tongue piece part 6h, and the tongue piece part 6j is provided with the protruded part 6n at the tip end of the tongue piece part 6j. The protruded part 6k and the protruded part 6n are formed in the same shape as each other. Both end faces in the front and rear direction of the protruded parts 6k and 6n are flat faces perpendicular to the front and rear direction.

Cut-out parts 3e (second cut-out part) for the projecting parts 6e which are cut out toward an inner side in the right and left direction, in other words, which are cut out toward inner sides from end faces of the bottom face part 3a in the width direction of a card 2, are formed on a front end side of the bottom face part 3a of the card reader 3. In other words, the second cut-out part 3e which is cut out from a right end face of the bottom face part 3a to a left side is formed on the front end side of the bottom face part 3a disposed on the right side, and the second cut-out part 3e which is cut out from a left end face of the bottom face part 3a to a right side is formed on the front end side of the bottom face part 3a disposed on the left side. Right and left inner side faces 3f of the second cut-out parts 3e (in other words, a left side face of the cut-out part 3e of the bottom face part 3a disposed on the right side, and a right side face of the cut-out part 3e of the bottom face part 3a disposed on the left side) are end faces which are perpendicular to the right and left direction. A front side face of the cut-out part 3e is an end face which is perpendicular to the front and rear direction.

The bottom face part 3a disposed on the left side is formed with two cut-out parts 3h and 3j which are cut out from a left end face of the bottom face part 3a toward a right side, in other words, which are cut out toward an inner side from the end face of the bottom face part 3a in the width direction of a card 2. The cut-out part 3h is formed on a rear side with respect to the cut-out part 3e, and the cut-out part 3j is formed on a rear side with respect to the cut-out part 3h. The cut-out part 3h and the cut-out part 3j are formed in the same shape as each other. A rear side face 3k of the cut-out part 3h and a rear side face 3n of the cut-out part 3j are end faces which are perpendicular to the front and rear direction. Further, a front side face of the cut-out part 3h and a front side face of the cut-out part 3j are end faces which are perpendicular to the front and rear direction. Further, a rear end face 3p of the bottom face part 3a is an end face which is perpendicular to the front and rear direction.

In a state that the card reader 3 is attached to the attaching frame 6a, the first contact parts 6f of the two projecting parts 6e formed on the rear side of the attaching frame 6a are disposed on the rear side of the bottom face part 3a of the card reader 3. Further, the first contact parts 6f of the two projecting parts 6e formed on the front side of the attaching frame 6a are disposed in the second cut-out parts 3e for the projecting parts 6e of the bottom face part 3a. Further, in the state that the card reader 3 is attached to the attaching frame 6a, the protruded part 6k of the tongue piece part 6h is disposed in the cut-out part 3h of the bottom face part 3a and the protruded part 6n of the tongue piece part 6j is disposed in the cut-out part 3j.

Further, in the state that the card reader 3 is attached to the attaching frame 6a, the rear side face 3n of the cut-out part 3j (first cut-out part) for the engaging part is contacted with the rear end face of the protruded part 6n of the tongue piece part 6j which is the engaging part, and the rear end face 3p of the bottom face part 3a is contacted with the front faces of the first contact parts 6f of the two projecting parts 6e formed on the rear side of the attaching frame 6a. Further, each of the inner side faces 3f of two second cut-out parts 3e for the projecting parts 6e is contacted with each of the inner side faces in the right and left direction of the first contact parts 6f of the two projecting parts 6e formed on the front side of the attaching frame 6a.

Further, in the state that the card reader 3 is attached to the attaching frame 6a, the upper face 3c of the bottom face part 3a is contacted with the under faces of the second contact parts 6g of the four projecting parts 6e. Specifically, the under faces of the second contact parts 6g of the two projecting parts 6e formed on the rear side of the attaching frame 6a are contacted with a rear end portion of the upper face 3c, and the under faces of the second contact parts 6g of the two projecting parts 6e formed on the front side of the attaching frame 6a are contacted with the front side portions of the upper face 3c with respect to the cut-out parts 3e. Further, the under face 3b of the bottom face part 3a is contacted with the attaching faces 6d of the attaching frame 6a.

As described above, in the state that the card reader 3 is attached to the attaching frame 6a, a relative movement to the front direction of the card reader 3 with respect to the attaching frame 6a is restricted by the rear side face 3n of the first cut-out part 3j and the protruded part 6n of the tongue piece part 6j, and a relative movement to the rear direction of the card reader 3 with respect to the attaching frame 6a is restricted by the rear end face 3p of the bottom face part 3a and the first contact parts 6f of the projecting parts 6e formed on the rear side of the attaching frame 6a.

Further, in the state that the card reader 3 is attached to the attaching frame 6a, movements to both right and left directions of the card reader 3 with respect to the attaching frame 6a are restricted by the inner side faces 3f of the two second cut-out parts 3e and the first contact parts 6f of the projecting parts 6e formed on the front side of the attaching frame 6a, and movements to both upper and lower directions of the card reader 3 with respect to the attaching frame 6a are restricted by the under face 3b and the upper face 3c of the bottom face part 3a and the second contact parts 6g of four projecting parts 6e and the attaching faces 6d.

In this embodiment, the attaching faces 6d, the projecting parts 6e and the tongue piece part 6j structure a restriction part 6r for restricting a relative movement of the card reader 3 with respect to the attaching frame 6a in the front and rear direction, the right and left direction and the upper and lower direction. In other words, the attaching frame 6a is provided with the restriction part 6r for restricting a relative movement of the card reader 3 with respect to the attaching frame 6a in the front and rear direction, the right and left direction and the upper and lower direction. The restriction part 6r in this embodiment is a frame side restriction part.

Further, in this embodiment, the rear side face 3n of the first cut-out part 3j, the rear end face 3p of the bottom face part 3a, the inner side face 3f of the second cut-out part 3e, and the under face 3b and the upper face 3c of the bottom face part 3a structure a restriction part 3r which is engaged with the restriction part 6r to restrict a relative movement of the card reader 3 in the front and rear direction, the right and left direction and the upper and lower direction with respect to the attaching frame 6a. In other words, the card reader 3 is provided with the restriction part 3r which is engaged with the restriction part 6r to restrict a relative movement of the card reader 3 with respect to the attaching frame 6a in the front and rear direction, the right and left direction and the upper and lower direction. Further, a part of the bottom face part 3a is structured to be the restriction part 3r. The restriction part 3r in this embodiment is a processing device side restriction part.

Further, the tongue piece part 6j in this embodiment is structured as an engaging part which is engaged with the rear side face 3n of the first cut-out part 3j, which is a part of the restriction part 3r, to restrict a relative movement to the front direction of the card reader 3 with respect to the attaching frame 6a. In other words, the tongue piece part 6j which is an engaging part is formed in the attaching frame 6a. Further, the restriction part 6r is provided with the projecting parts 6e which restrict a relative movement of the card reader 3 with respect to the attaching frame 6a to four directions except the front direction and the lower direction (in other words, to the rear direction, to both right and left directions, and to the upper direction). The front direction in this embodiment is a first restriction direction which is a one-side direction in the conveying direction of a card 2.

Further, in this embodiment, the rear side face 3n of the first cut-out part 3j is a first contact face which is contacted with the tongue piece part 6j which is an engaging part to restrict a relative movement to the front direction of the card reader 3 with respect to the attaching frame 6a. Further, the inner side faces 3f of the second cut-out parts 3e are second contact faces which are contacted with the first contact parts 6f of the projecting parts 6e to restrict a relative movement to the right and left directions of the card reader 3 with respect to the attaching frame 6a. In addition, the upper face 3c of the bottom face part 3a is a third contact face which is contacted with the second contact part 6g of the projecting part 6e to restrict a relative movement of the card reader 3 to the upper direction with respect to the attaching frame 6a. Further, the rear end face 3p of the bottom face part 3a is a fourth contact face which is contacted with the first contact part 6f of the projecting part 6e to restrict a relative movement to the rear direction of the card reader 3 with respect to the attaching frame 6a.

In this embodiment, when the card reader 3 is attached to the attaching frame 6a, slight gap spaces are formed between the front faces of the first contact parts 6f of two projecting parts 6e formed on the front side of the attaching frame 6a and the front side faces of the cut-out parts 3e, and slight gap spaces are formed between the rear side face 3k of the cut-out part 3h and the rear end face of the protruded part 6k of the tongue piece part 6h. Further, in the state that the card reader 3 is attached to the attaching frame 6a, a space is formed between the front side face of the cut-out part 3h and the front end face of the protruded part 6k of the tongue piece part 6h, and a space is formed between the front side face of the cut-out part 3j and the front end face of the protruded part 6n of the tongue piece part 6j.

As described above, the tongue piece part 6j is structured to be an elastic piece which is capable of elastically deformed in the upper and lower direction with the right end of the tongue piece part 6j as a supporting point. When an external force is not applied to the tongue piece part 6j, the protruded part 6n of the tongue piece part 6j is disposed in the cut-out part 3j and a relative movement to the front direction of the card reader 3 with respect to the attaching frame 6a is restricted. Further, when a predetermined external force is applied to the tongue piece part 6j to a lower direction, the tongue piece part 6j is capable of elastically deformed to a lower side until the protruded part 6n is disengaged from the cut-out part 3j to release restriction of a relative movement to the front direction of the card reader 3 with respect to the attaching frame 6a.

In other words, the tongue piece part 6j is capable of elastically deformed from a restricting position, where the rear end face of the protruded part 6n of the tongue piece part 6j is contacted with the rear side face 3n of the cut-out part 3j to restrict a relative movement to the front direction of the card reader 3 with respect to the attaching frame 6a, to a release position where the contact state of the rear end face of the protruded part 6n of the tongue piece part 6j with the rear side face 3n of the cut-out part 3j is released to permit a relative movement to the front direction of the card reader 3 with respect to the attaching frame 6a. The cut-out part 6p (third cut-out part) which is formed on the lower side with respect to the tongue piece part 6j is formed so that the tongue piece part 6j is elastically deformed from the restricting position to the release position. Similarly, when an external force is not applied to the tongue piece part 6h, the protruded part 6k of the tongue piece part 6h is disposed in the cut-out part 3h. Further, when a predetermined external force is applied to the tongue piece part 6h to a lower direction, the tongue piece part 6h is elastically deformed to a lower side and becomes a state that the protruded part 6k is disengaged from the cut-out part 3h.

In this embodiment, the card reader 3 is slid on the attaching face 6d (frame side attaching face) of the attaching frame 6a from the front side of the attaching frame 6a toward the rear side to attach the card reader 3 to the attaching frame 6a. When the card reader 3 is to be slid with respect to the attaching frame 6a, external forces are applied to the tongue piece parts 6h and 6j and the tongue piece parts 6h and 6j are elastically deformed to a lower side, i.e., to a release position so that the protruded part 6k of the tongue piece part 6h and the protruded part 6n of the tongue piece part 6j are not contacted with the bottom face part 3a. Further, when the rear end face 3p of the bottom face part 3a of the card reader 3 which is slid to the rear side is contacted with the front faces of the first contact parts 6f of the two projecting parts 6e formed on the rear side of the attaching frame 6a, the external forces applied to the tongue piece parts 6h and 6j are released. When the external forces applied to the tongue piece parts 6h and 6j are released, the protruded part 6k is disposed in the cut-out part 3h and the protruded part 6n is disposed in the cut-out part 3j.

Further, when the external force applied to the tongue piece part 6j is released, the rear end face of the protruded part 6n is contacted with the rear side face 3n of the cut-out part 3j and the tongue piece part 6j is engaged with the rear side face 3n of the first cut-out part 3j for the engaging part. In other words, in a state that the tongue piece part 6j is resiliently bent to the release position, the card reader 3 can be slid until the rear end face 3p of the bottom face part 3a is contacted with the front faces of the first contact parts 6f of the two projecting parts 6e formed on the rear side of the attaching frame 6a and then, the external force applied to the tongue piece part 6j is released. As a result, the tongue piece part 6j is engaged with the rear side face 3n of the cut-out part 3j and the tongue piece part 6j is engaged with the rear side face 3n of the cut-out part 3j by snap fitting which utilizes elasticity of the tongue piece part 6j. In this embodiment, when the card reader 3 is attached to the attaching frame 6a, the positioning projections 6c of the cassette attachment and detachment frame 6b are engaged with engagement holes of the card reader 3.

The lock member 8 is formed of resin. Further, as shown in FIG. 6, the lock member 8 is formed in a substantially “U”-shape. One of two lock members 8 is, as shown in FIGS. 7A and 7B, fitted to the cut-out part 6p (third cut-out part) formed on a lower side of the tongue piece part 6j and prevents the tongue piece part 6j from being elastically deformed from the restricting position to the release position. Further, the other of two lock members 8 is fitted to the cut-out part 6p formed on a lower side of the tongue piece part 6h and prevents the tongue piece part 6h from being elastically deformed to the lower side.

The lock member 8 is fitted to the cut-out part 6p so that an opening side of the lock member 8 formed in a substantially “U”-shape is disposed on a left side. Further, the lock member 8 is disposed in the cut-out part 6p in a state that the opening side of the lock member 8 is resiliently bent to an inner side in the front and rear direction and then, the external force applied to the lock member 8 is released. As a result, the lock member 8 is engaged with the cut-out part 6p and the lock member 8 is engaged with the cut-out part 6p by snap fitting which utilizes elasticity of the lock member 8. In this embodiment, the card reader 3 is slid from the front side of the attaching frame 6a to the rear side and, after the card reader 3 is attached to the attaching frame 6a, as shown in FIGS. 7A and 7B, the lock member 8 is fitted into the cut-out part 6p from a left side.

### Principal Effects in this Embodiment

As described above, in this embodiment, a relative movement of the card reader 3 with respect to the attaching frame 6a is restricted by the restriction part 6r of the attaching frame 6a and the restriction part 3r of the card reader 3 in the front and rear direction, the right and left direction and the upper and lower direction. Therefore, according to this embodiment, a screw for fixing the card reader 3 to the attaching frame 6a is not required. Accordingly, in this embodiment, the number of components of the card issuing device 1 can be reduced.

In this embodiment, the card reader 3 is slid from a front side to a rear side for attaching the card reader 3 to the attaching frame 6a so that the rear side face 3n of the cut-out part 3j (first cut-out part) is contacted with the tongue piece part 6j, the rear end face 3p of the bottom face part 3a is contacted with a front face of the first contact part 6f of the projecting part 6e formed on a rear side of the attaching frame 6a, the inner side faces 3f of the two cut-out parts 3e (second cut-out part) are contacted with the right and left inner side faces of the first contact parts 6f of the projecting parts 6e formed on the front side of the attaching frame 6a, the upper face 3c of the bottom face part 3a is contacted with the under face of the second contact part 6g of the projecting part 6e, and the under face 3b of the bottom face part 3a is contacted with the attaching face 6d. Further, in this embodiment, the tongue piece part 6j is engaged with the rear side face 3n of the cut-out part 3j (first cut-out part) by snap fitting utilizing elasticity of the tongue piece part 6j which is capable of being elastically deformed from a restricting position to a release position, and the card reader 3 is fixed to the attaching frame 6a by snap fitting which utilizes elasticity of the tongue piece part 6j. Therefore, according to this embodiment, an attaching time for attaching the card reader 3 to the attaching frame 6a can be reduced in comparison with a case that the card reader 3 is fixed to the attaching frame 6a with a screw.

In this embodiment, a relative movement to the front direction of the card reader 3 with respect to the attaching frame 6a is restricted by the tongue piece part 6j which is capable of being elastically deformed from a restricting position to a release position. Further, the card reader 3 is slid from the front side toward the rear side and thereby the card reader 3 is attached to the attaching frame 6a. Therefore, according to this embodiment, even when a positioning projection 6c is formed on a front face of the cassette attachment and detachment frame 6b, the card reader 3 can be attached to the attaching frame 6a.

In this embodiment, a relative movement to a front direction of the card reader 3 with respect to the attaching frame 6a is restricted by the rear side face 3n of the cut-out part 3j (first cut-out part) and the protruded part 6n of the tongue piece part 6j, a relative movement to a rear direction of the card reader 3 with respect to the attaching frame 6a is restricted by the rear end face 3p of the bottom face part 3a and the first contact part 6f of the projecting part 6e formed on the rear side of the attaching frame 6a, movements to both right and left directions of the card reader 3 with respect to the attaching frame 6a are restricted by the inner side faces 3f of the cut-out parts 3e (second cut-out part) and the first contact parts 6f of the projecting parts 6e formed on a front side of the attaching frame 6a, and movements to both upper and lower directions of the card reader 3 with respect to the attaching frame 6a are restricted by the under face 3b and the upper face 3c of the bottom face part 3a and the second contact parts 6g of four projecting parts 6e and the attaching face 6d. Therefore, according to this embodiment, a relative movement of the card reader 3 with respect to the attaching frame 6a can be restricted with a relatively simple structure in the front and rear direction, the right and left direction and the upper and lower direction.

Further, in this embodiment, a relative movement of the card reader 3 with respect to the attaching frame 6a can be restricted by using the projecting parts 6e in four (4) directions except the front direction and the lower direction (in other words, to the rear direction, both the right and left directions and the upper direction) and thus a structure of the attaching frame 6b can be simplified.

In this embodiment, the cut-out part 6p (third cut-out part) for elastically deforming the tongue piece part 6j from the restricting position to the release position is formed on a lower side with respect to the tongue piece part 6j. On the other hand, the lock member 8 which prevents the tongue piece part 6j from being elastically deformed from the restricting position to the release position is fitted to the cut-out part 6p. Therefore, according to this embodiment, after the card reader 3 has been attached to the attaching frame 6a, it is prevented that the tongue piece part 6j is elastically deformed from the restricting position to the release position and thereby the card reader 3 is disengaged from the attaching frame 6a. Further, in this embodiment, the lock member 8 is engaged with the cut-out part 6p by snap fitting which utilizes elasticity of the lock member 8 and thus, even when the lock member 8 is fitted to the cut-out part 6p, an attaching time of the card reader 3 to the attaching frame 6a can be shortened.

### Other Embodiments

Although the present invention has been shown and described with reference to a specific embodiment, various changes and modifications will be apparent to those skilled in the art from the teachings herein.

In the embodiment described above, it may be structured that, when the card reader 3 is attached to the attaching frame 6a, the front side face of the cut-out part 3j and the front end face of the protruded part 6n of the tongue piece part 6j are contacted with each other. In this case, for example, spaces are formed between the front faces of the first contact parts 6f of the two projecting parts 6e formed on the rear side of the attaching frame 6a and the rear end face 3p of the bottom face part 3a. In this case, a relative movement to both front and rear directions of the card reader 3 with respect to the attaching frame 6a is restricted by the rear side face 3n and the front side face of the cut-out part 3j (first cut-out part) and the protruded part 6n of the tongue piece part 6j.

In this case, the front side face of the cut-out part 3j structures a part of the restriction part 3r and the front and rear direction is the first restriction direction. Further, the front side face of the cut-out part 3j is the first contact face contacted with the tongue piece part 6j which is the engaging part. Further, in this case, the tongue piece part 6j is engaged with the rear side face 3n and the front side face of the cut-out part 3j by snap fitting. Further, in this case, a relative movement of the card reader 3 with respect to the attaching frame 6a in three directions except the front and rear direction and the lower direction (in other words, both right and left directions and upper direction) is restricted by utilizing the projecting part 6e.

In the embodiment described above, it may be structured that, when the card reader 3 is attached to the attaching frame 6a, the rear side face 3k of the cut-out part 3h and the rear end face of the protruded part 6k of the tongue piece part 6h are contacted with each other. In this case, the rear side face 3k of the cut-out part 3h as the first cut-out part structures a part of the restriction part 3r. Further, the tongue piece part 6h is an engaging part engaged with the rear side face 3k of the cut-out part 3h (first cut-out part), which is a part of the restriction part 3r, to restrict a relative movement to the front direction of the card reader 3 with respect to the attaching frame 6a. Further, in the embodiment described above, it may be structured that, when the card reader 3 is attached to the attaching frame 6a, the front side faces of the cut-out parts 3e are contacted with the front faces of the first contact parts 6f of two projecting parts 6e formed on the front side of the attaching frame 6a.

In the embodiment described above, it may be structured that the projecting part 6e is formed in an “L”-shape when viewed in the front and rear direction. In other words, the projecting part 6e may be structured of a first contact part 6f formed so as to extend to an upper side and a second contact part 6g which is extended from a tip end (upper end) of the first contact part 6f to a right side or a left side.

In the embodiment described above, it may be structured that the projecting part 6e is provided with a protruded part which is protruded to a lower side from a tip end (front end) of the second contact part 6g. In this case, a rear face of the protruded part is formed to be a flat face perpendicular to the front and rear direction. Further, the bottom face part 3a is formed with an engagement hole or a cut-out part to which the protruded part is fitted. In a state that the card reader 3 is attached to the attaching frame 6a, a rear side face of the engagement hole or the cut-out part is contacted with the rear face of the protruded part and a relative movement to the front direction of the card reader 3 with respect to the attaching frame 6a is restricted by the rear face of the protruded part and the rear side face of the engagement hole or the cut-out part. In other words, in this case, a relative movement of the card reader 3 with respect to the attaching frame 6a to the front and rear direction, the right and left direction and the upper direction is restricted by using the projecting part 6e.

Further, in this case, the projecting part 6e is structured to be an elastic piece which is capable of being elastically deformed from a restricting position where a relative movement to the front direction of the card reader 3 with respect to the attaching frame 6a is restricted (in other words, a position where the rear side face of the engagement hole or the cut-out part and the rear face of the protruded part are contacted with each other) to a release position where the restriction of the relative movement to the front direction of the card reader 3 with respect to the attaching frame 6a is released (in other words, where the protruded part is retreated to an upper side with respect to the engagement hole or the cut-out part). Therefore, the projecting part 6e is engaged with the rear side face of the engagement hole or the cut-out part by snap fitting. In this case, the rear side face of the engagement hole or the cut-out part structures a part of the restriction part 3r. Further, in this case, the projecting part 6e is an engaging part and thus the tongue piece part 6j is not required.

In the embodiment described above, it may be structured that movements of the card reader 3 with respect to the attaching frame 6a in both front and rear directions and to the upper direction are restricted by utilizing the projecting part 6e, and movements in both right and left directions of the card reader 3 with respect to the attaching frame 6a are restricted by an engaging part which is capable of being elastically deformed from a restricting position, where a relative movement in the right and left direction of the card reader 3 with respect to the attaching frame 6a is restricted, to a release position where restriction of the relative movement in the right and left direction of the card reader 3 with respect to the attaching frame 6a is released. In this case, the right and left direction is the first restriction direction.

Further, it may be structured that movements of the card reader 3 with respect to the attaching frame 6a to the left direction, both front and rear directions and to the upper direction are restricted by utilizing the projecting part 6e and, in addition, movement to the right direction of the card reader 3 with respect to the attaching frame 6a is restricted by an engaging part which is capable of being elastically deformed from a restricting position where a relative movement to the right direction of the card reader 3 with respect to the attaching frame 6a is restricted to a release position where restriction of the relative movement to the right direction of the card reader 3 with respect to the attaching frame 6a is released. In this case, the right direction is the first restriction direction.

Further, it may be structured that movements of the card reader 3 with respect to the attaching frame 6a to the right direction, both front and rear directions and to the upper direction are restricted by utilizing the projecting part 6e and, in addition, movement to the left direction of the card reader 3 with respect to the attaching frame 6a is restricted by an engaging part which is capable of being elastically deformed from a restricting position where a relative movement to the left direction of the card reader 3 with respect to the attaching frame 6a is restricted to a release position where restriction of the relative movement to the left direction of the card reader 3 with respect to the attaching frame 6a is released. In this case, the left direction is the first restriction direction.

In these cases, the engaging part is engaged with a part of the bottom face part 3a by snap fitting. Further, in these cases, the card reader 3 is attached to the attaching frame 6a by sliding the card reader 3 from a right side of the attaching frame 6a to a left side, or sliding the card reader 3 from a left side of the attaching frame 6a to a right side.

Further, in the embodiment described above, it may be structured that movements of the card reader 3 with respect to the attaching frame 6a to both front and rear directions and both right and left directions are restricted by utilizing the projecting part 6e structured of only the first contact part 6f and, in addition, a movement to an upper direction of the card reader 3 with respect to the attaching frame 6a is restricted by an engaging part which is capable of being elastically deformed from a restricting position where a relative movement to the upper direction of the card reader 3 with respect to the attaching frame 6a is restricted to a release position where restriction of the relative movement to the upper direction of the card reader 3 with respect to the attaching frame 6a is released. In this case, the upper direction is the first restriction direction.

Further, it may be structured that movements of the card reader 3 with respect to the attaching frame 6a to both front and rear directions and both right and left directions are restricted by utilizing the projecting part 6e structured of only the first contact part 6f and, in addition, a movement in an upper and lower direction of the card reader 3 with respect to the attaching frame 6a is restricted by an engaging part which is capable of being elastically deformed from a restricting position where a relative movement in the upper and lower direction of the card reader 3 with respect to the attaching frame 6a is restricted to a release position where restriction of the relative movement to the upper and lower direction of the card reader 3 with respect to the attaching frame 6a is released. In this case, the upper and lower direction is the first restriction direction.

In these cases, the engaging part is engaged with a part of the bottom face part 3a by snap fitting. Further, in these cases, the card reader 3 is attached to the attaching frame 6a from an upper side.

In the embodiment described above, the lock member 8 is engaged with the cut-out part 6p by snap fitting which utilizes elasticity of the lock member 8. However, the lock member 8 inserted into the cut-out part 6p may be fixed to the attaching frame 6a by using a screw or the like. Further, in the embodiment described above, it may be structured that no lock member 8 is fitted to the cut-out part 6p of the attaching frame 6a.

In the embodiment described above, structures corresponding to the projecting parts 6e and the tongue piece parts 6h and 6j may be formed in the card reader 3. However, when the projecting parts 6e and the tongue piece parts 6h and 6j are formed in the attaching frame 6a made of resin as described in the embodiment described above, the tongue piece parts 6h and 6j which are elastic pieces and the projecting parts 6e can be formed easily. Further, when the projecting parts 6e and the tongue piece parts 6h and 6j are formed in the attaching frame 6a as described in the above-mentioned embodiment, the structure of the card reader 3 can be simplified.

In the embodiment described above, instead of the card reader 3, a printer structured to print on a surface of a card 2, an image sensor structured to read printed characters or the like on a surface of a card 2, or a switching unit structured to switch a conveying direction of a card 2 or the like may be attached to the attaching frame 6a. In other words, the card processing unit 3 may be a device other than a card reader. Further, in the embodiment described above, the attaching structure 7 of the card reader may be used in a device other than a card issuing device 1.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An attaching structure of a card processing unit for use with a card, the attaching structure comprising:
the card processing unit structured to perform predetermined processing on the card; and
an attaching frame to which the card processing unit is attached;
wherein when a direction which is perpendicular to a conveying direction of the card conveyed in the card processing unit and is perpendicular to a thickness direction of the card conveyed in the card processing unit is referred to as a width direction of the card, the attaching frame comprises a frame side restriction part structured to restrict a relative movement of the card processing unit with respect to the attaching frame in the conveying direction of the card, the thickness direction of the card and the width direction of the card, and the card processing unit comprises a processing unit side restriction part structured to engage with the frame side restriction part to restrict the relative movement of the card processing unit with respect to the attaching frame in the conveying direction of the card, the thickness direction of the card and the width direction of the card;
wherein one of the frame side restriction part and the processing unit side restriction part comprises an engaging part structured to engage with a part of the other of the frame side restriction part and the processing unit side restriction part to restrict the relative movement of the card processing unit with respect to the attaching frame toward a first restriction direction, the first restriction direction being at least a one-side direction in the conveying direction of the card, at least a one-side direction in the thickness direction of the card, or at least a one-side direction in the width direction of the card;
wherein the engaging part is an elastic piece which is elastically deformable from a restricting position, where the relative movement of the card processing unit with respect to the attaching frame toward the first restriction direction is restricted, to a release position where restriction of the relative movement of the card processing unit with respect to the attaching frame toward the first restriction direction is released; and
wherein the engaging part is engaged with the part of the other of the frame side restriction part and the processing unit side restriction part by snap fitting.

2. The attaching structure of a card processing unit according to claim 1, wherein
the attaching frame is formed of resin,
the engaging part is formed in the attaching frame,
the attaching frame comprises a frame side attaching face in a flat face shape to which the card processing unit is attached,
the card processing unit comprises an attached part in a flat plate shape which is formed with a processing unit side attaching face in a flat face shape which is contacted with the frame side attaching face,
the frame side attaching face and the processing unit side attaching face are flat faces perpendicular to the thickness direction of the card,
the frame side restriction part comprises a projecting part structured to restrict a relative movement of the card processing unit with respect to the attaching frame in three directions or four directions except the first restriction direction and a one-side direction in the thickness direction of the card,
the projecting part is protruded to a side of the card processing unit with respect to the frame side attaching face, and
a part of the attached part is the processing unit side restriction part.

3. The attaching structure of a card processing unit according to claim 2, wherein
the first restriction direction is at least a one-side direction in the conveying direction of the card,
the attached part comprises:
a first contact face structured to contact with the engaging part to restrict a relative movement of the card processing unit with respect to the attaching frame toward the first restriction direction;
a second contact face structured to contact with the projecting part to restrict a relative movement of the card processing unit with respect to the attaching frame toward the width direction of the card; and
a third contact face structured to contact with the projecting part to restrict a relative movement of the card processing unit with respect to the attaching frame toward the other direction in the thickness directions of the card, and
the projecting part comprises a first contact part structured to contact with the second contact face and a second contact part structured to contact with the third contact face.

4. The attaching structure of a card processing unit according to claim 3, wherein
the first restriction direction is a one-side direction in the conveying direction of the card, and
the attached part comprises a fourth contact face structured to contact with the first contact part to restrict a relative movement of the card processing unit with respect to the attaching frame toward an opposite direction to the first restriction direction.

5. The attaching structure of a card processing unit according to claim 3, wherein
the projecting part comprises the first contact part and the second contact part,
the first contact part extends to one side in the thickness direction of the card,
the second contact part extends from a tip end of the first contact part to one side in the conveying direction of the card, and
a shape of the projecting part when viewed in the width direction of the card is an “L”-shape.

6. The attaching structure of a card processing unit according to claim 2, wherein
the attached part is a bottom face part which structures an under face of the card processing unit and is formed of sheet steel,
the bottom face part comprises:
a first cut-out part which is formed by cutting out an end face of the bottom face part in the width direction of the card to an inner side and is structured to be engaged with the engaging part formed in the attaching frame; and
a second cut-out part which is formed by cutting out an end face of the bottom face part in the width direction of the card to an inner side and is structured to engage with the projecting part formed in the attaching frame, and
when the card processing unit is attached to the attaching frame, the engaging part formed in the attaching frame is engaged with the first cut-out part and the projecting part formed in the attaching frame is engaged with the second cut-out part.

7. The attaching structure of a card processing unit according to claim 6, wherein
the first cut-out part provided in the bottom face part comprises a first contact face structured to contact with the engaging part to restrict a movement of the bottom face part with respect to the attaching frame toward the first restriction direction,
the second cut-out part provided in the bottom face part comprises a second contact face structured to contact with the projecting part to restrict a movement of the bottom face part with respect to the attaching frame toward the width direction of the card, and
the projecting part comprises a first contact part structured to contact with the second contact face and a second contact part structured to restrict a movement of the bottom face part toward the other direction in the thickness direction of the card.

8. The attaching structure of a card processing unit according to claim 7, wherein
the projecting part comprises the first contact part and the second contact part,
the first contact part extends to one side in the thickness direction of the card,
the second contact part extends from a tip end of the first contact part to one side in the conveying direction of the card, and
a shape of the projecting part when viewed in the width direction of the card is an “L”-shape.

9. The attaching structure of a card processing unit according to claim 8, wherein
the projecting part is provided at both end parts of the attaching frame in the width direction of the card,
the second cut-out part formed in the bottom face part is provided at two positions so as to correspond to the projecting parts provided at the both end parts of the attaching frame in the width direction of the card, and
the second cut-out parts provided at the two positions in the bottom face part are structured to contact with the projecting parts to restrict a movement of the bottom face part in the width direction of the card.

10. The attaching structure of a card processing unit according to claim 6, wherein
the engaging part is a tongue piece part formed in a tongue piece shape which is connected with a main body part of the attaching frame,
a tip end of the tongue piece part comprises a protruded part structured to engage with the first cut-out part formed in the bottom face part, and
when the card processing unit is to be attached to the attaching frame, the card processing unit is slid on the frame side attaching face in the flat face shape in a state that the tongue piece part provided with the protruded part is elastically deformed to the release position, and thereby the first cut-out part formed in the bottom face part and the protruded part provided at the tip end of the tongue piece part are engaged with each other.

11. The attaching structure of a card processing unit according to claim 1, further comprising a lock member structured to prevent the engaging part from being elastically deformed from the restricting position to the release position,
wherein the engaging part is formed in the attaching frame,
wherein the attaching frame comprises a third cut-out part structured to permit the engaging part to elastically deform from the restricting position to the release position, and
wherein the lock member is fitted to the third cut-out part.

12. The attaching structure of a card processing unit according to claim 11, wherein
the lock member is formed in a substantially “U”-shape, and
the lock member is engaged with the third cut-out part by snap fitting.

13. The attaching structure of a card processing unit according to claim 11, wherein
the attaching frame is formed of resin,
the attaching frame comprises a frame side attaching face in a flat face shape to which the card processing unit is attached,
the card processing unit comprises an attached part in a flat plate shape which is formed with a processing unit side attaching face in a flat face shape which is contacted with the frame side attaching face,
the frame side attaching face and the processing unit side attaching face are formed to be flat faces perpendicular to the thickness direction of the card,
the frame side restriction part comprises a projecting part structured to restrict a relative movement of the card processing unit with respect to the attaching frame in three directions or four directions except the first restriction direction and a one-side direction in the thickness direction of the card,
the projecting part is protruded to a side of the card processing unit with respect to the frame side attaching face, and
a part of the attached part is the processing unit side restriction part.

14. The attaching structure of a card processing unit according to claim 13, wherein
the attached part is a bottom face part which structures an under face of the card processing unit and is formed of sheet steel,
the bottom face part comprises:
a first cut-out part which is formed by cutting out an end face of the bottom face part in the width direction of the card to an inner side and is structured to be engaged with the engaging part formed in the attaching frame; and
a second cut-out part which is formed by cutting out an end face of the bottom face part in the width direction of the card to an inner side and is structured to engage with the projecting part formed in the attaching frame, and
when the card processing unit is attached to the attaching frame, the engaging part formed in the attaching frame is engaged with the first cut-out part and the projecting part formed in the attaching frame is engaged with the second cut-out part.

15. The attaching structure of a card processing unit according to claim 14, wherein
the first cut-out part provided in the bottom face part comprises a first contact face structured to contact with the engaging part to restrict a movement of the bottom face part with respect to the attaching frame toward the first restriction direction,
the second cut-out part provided in the bottom face part comprises a second contact face structured to contact with the projecting part to restrict a movement of the bottom face part with respect to the attaching frame toward the width direction of the card, and
the projecting part comprises a first contact part structured to contact with the second contact face and a second contact part structured to restrict a movement of the bottom face part toward the other direction in the thickness direction of the card.

16. The attaching structure of a card processing unit according to claim 14, wherein
the engaging part is a tongue piece part formed in a tongue piece shape which is connected with a main body part of the attaching frame,
a tip end of the tongue piece part comprises a protruded part structured to engage with the first cut-out part formed in the bottom face part,
when the card processing unit is to be attached to the attaching frame, the card processing unit is slid on the frame side attaching face in the flat face shape in a state that the tongue piece part provided with the protruded part is elastically deformed to the release position, and thereby the first cut-out part formed in the bottom face part and the protruded part provided at the tip end of the tongue piece part are engaged with each other, and
the lock member is fitted to the third cut-out part in a state that the first cut-out part and the protruded part provided at the tip end of the tongue piece part are engaged with each other.

17. A card issuing device comprising:
the attaching structure of the card processing unit defined in claim 1;
a card cassette in which cards before issue are accommodated in a stacked state;
a cassette attachment and detachment frame to which the card cassette is detachably attached; and
a card feed mechanism structured to feed out the card from the card cassette toward the card processing unit;
wherein the attaching frame and the cassette attachment and detachment frame are formed of resin and are integrally formed with each other.

18. The card issuing device according to claim 17, wherein
the card processing unit and the card cassette are disposed so as to be adjacent to each other in the conveying direction of the card,
the first restriction direction is at least a one-side direction in the conveying direction of the card, and
when a side where the card processing unit is disposed with respect to the card cassette in the conveying direction of the card is referred to as a front side, a front face of the cassette attachment and detachment frame is formed with a positioning projection structured to position the card processing unit with respect to the cassette attachment and detachment frame at least one in the thickness direction of the card and the width direction of the card.

19. The card issuing device according to claim 17, wherein
the attaching frame is formed of resin,
the engaging part is formed in the attaching frame,
the attaching frame is formed with a frame side attaching face in a flat face shape to which the card processing unit is attached,
the card processing unit comprises an attached part in a flat plate shape which is formed with a processing unit side attaching face in a flat face shape which is contacted with the frame side attaching face,
the frame side attaching face and the processing unit side attaching face are formed to be flat faces perpendicular to the thickness direction of the card,
the frame side restriction part comprises a projecting part structured to restrict a relative movement of the card processing unit with respect to the attaching frame in three directions or four directions except the first restriction direction and a one-side direction in the thickness direction of the card,
the projecting part is protruded to a side of the card processing unit with respect to the frame side attaching face, and
a part of the attached part is the processing unit side restriction part.

20. The card issuing device according to claim 19, wherein
the attached part is a bottom face part which structures an under face of the card processing unit and is formed of sheet steel,
the bottom face part comprises:
a first cut-out part which is formed by cutting out an end face of the bottom face part in the width direction of the card to an inner side and is structured to be engaged with the engaging part formed in the attaching frame; and
a second cut-out part which is formed by cutting out an end face of the bottom face part in the width direction of the card to an inner side and is structured to engage with the projecting part formed in the attaching frame, and
when the card processing unit is attached to the attaching frame, the engaging part formed in the attaching frame is engaged with the first cut-out part and the projecting part formed in the attaching frame is engaged with the second cut-out part.

21. The card issuing device according to claim 20, wherein
the first cut-out part provided in the bottom face part comprises a first contact face structured to contact with the engaging part to restrict a movement of the bottom face part with respect to the attaching frame toward the first restriction direction,
the second cut-out part provided in the bottom face part comprises a second contact face structured to contact with the projecting part to restrict a movement of the bottom face part with respect to the attaching frame toward the width direction of the card, and
the projecting part comprises a first contact part structured to contact with the second contact face and a second contact part structured to restrict a movement of the bottom face part toward the other direction in the thickness direction of the card.

22. The card issuing device according to claim 21, wherein
the projecting part is provided at both end parts of the attaching frame in the width direction of the card,
the second cut-out part formed in the bottom face part is provided at two positions so as to correspond to the projecting parts provided at the both end parts of the attaching frame in the width direction of the card, and
the second cut-out parts provided at the two positions in the bottom face part are structured to contact with the projecting parts to restrict a movement of the bottom face part in the width direction of the card.

23. The card issuing device according to claim 20, wherein
the engaging part is a tongue piece part formed in a tongue piece shape which is connected with a main body part of the attaching frame,
a tip end of the tongue piece part comprises a protruded part structured to engage with the first cut-out part formed in the bottom face part, and
when the card processing unit is to be attached to the attaching frame, the card processing unit is slid on the frame side attaching face in the flat face shape in a state that the tongue piece part provided with the protruded part is elastically deformed to the release position, and thereby the first cut-out part formed in the bottom face part and the protruded part provided at the tip end of the tongue piece part are engaged with each other.

24. The card issuing device according to claim 17, further comprising a lock member structured to prevent the engaging part from being elastically deformed from the restricting position to the release position,
wherein the engaging part is formed in the attaching frame,
wherein the attaching frame comprises a third cut-out part structured to permit the engaging part to elastically deform from the restricting position to the release position, and
wherein the lock member is fitted to the third cut-out part.

25. The card issuing device according to claim 24, wherein
the lock member is formed in a substantially “U”-shape, and
the lock member is engaged with the third cut-out part by snap fitting.
